(19) United States
(12) Patent Application Publication
(10) Pub. No.: US 2008/0040292 A1
(43) Pub. Date: Feb. 14, 2008

(54) COST INFORMATION MANAGEMENT SYSTEM, COST INFORMATION MANAGEMENT METHOD, AND COST INFORMATION MANAGEMENT PROGRAM

(75) Inventor: Yasuo NAKAYASHIKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/859,081

(22) Filed: Sep. 21, 2007

Related U.S. Application Data
(63) Continuation of application No. PCT/JP2005/005130, filed on Mar. 22, 2005.

(51) Int. Cl. G06F 17/00

(52) U.S. Cl. 705/400

(57) ABSTRACT

In order to provide a cost information management system and the like capable of performing cost estimation with a high level of accuracy without relying on a specialist skill, the cost information management system comprises: an input section that inputs functional parameters for respective circuits constituting the apparatus in the planning and design stages and a setting value of apparatus desired cost; a controller that calculates the apparatus cost in the planning stage based on the main functional parameters input by the input section, compares the calculated value with apparatus desired cost to determine whether to move to the design stage, additionally sets other functional parameters that have not been set in the planning stage in the case where it has been determined to move to the design stage so as to calculate the apparatus cost in the design stage, compares the calculated value with apparatus desired cost, and ends the apparatus development process in the case where the apparatus cost in the design stage is not more than the apparatus desired cost; and an output section that outputs the apparatus cost in the planning and design stages calculated by the controller.

### TECHNICAL FIELD

The present invention relates to one that estimates the cost of an apparatus composed of a plurality of components, such as a communication apparatus or information processing apparatus and, more particularly to a cost information management system, a cost information management method, and a cost information management program configured to cover the entire design process of the apparatus from, e.g., the design upstream stage (development and planning stage) to design down stream stage (detailed design stage) so as to estimate the cost of the apparatus.

### BACKGROUND ART

Conventionally, when the cost of an apparatus was calculated, a specialist sets a price based on experience or skill, or, sometimes, by intuition with reference to the design drawing of the target apparatus. In the information system field, the cost of an apparatus was estimated by appropriately correcting the cost of each component based on previous manufacturing process data or CAD shape data pertaining to a similar component and manufacturing cost data pertaining to the similar component (refer to, e.g., Patent Document 1).

Patent Document 1: Jpn. Pat. Appln. Laid-Open Publication No. 2002-182732

### DISCLOSURE OF INVENTION

### Problems to be Solved by the Invention

However, in the above method, estimated cost may fluctuate depending on experience or skill level of the specialist. In addition, cost estimation cannot be performed without previous manufacturing process data or CAD shape data concerning similar component. Further, a detailed design drawing or CAD data is not generally prepared in the development and planning stage of a target apparatus, which does not allow the specialist or system to perform cost estimation. In this case, there is no choice but to start a development project with the cost of the entire apparatus and therefore profit and loss forecast remaining obscure.

The present invention has been made to the above problems, and an object thereof is to provide a cost information management system, a cost information management method, and a cost information management program which are capable of performing cost estimation with a high level of accuracy without relying on a specialist skill and capable of covering the entire design process of the apparatus from the design upstream stage (development and planning stage) to design down stream stage (detailed design stage) of design.

### Means for Solving the Problems

To solve the above problems, according to an aspect of the present invention, there is provided a cost information management system that manages cost information relating to production of an apparatus in first and second stages of the production, comprising: an input section that inputs functional parameters for respective circuits constituting the apparatus in the first and second stages and a setting value of apparatus desired cost; and a controller that calculates the apparatus cost in the first stage based on the main functional parameters input by the input section, compares the calculated value with apparatus desired cost to determine whether to move to the second stage, additionally sets other functional parameters that have not been set in the first stage in the case where it has been determined to move to the second stage so as to calculate the apparatus cost in the second stage, and compares the calculated value with apparatus desired cost.

Further, in the cost information management system according to the present invention, the controller ends the apparatus development process in the case where the apparatus cost in the second stage is not more than the apparatus desired cost.

Further, the cost information management system according to the present invention comprises an output section that outputs the apparatus cost in the first and second stages calculated by the controller.

Further, the cost information management system according to the present invention comprises a storage section having a cost table in which costs corresponding to the functional parameters set for the respective circuits constituting the apparatus are previously stored, and the controller refers to the cost table stored in the storage section to obtain the costs of the respective circuits which correspond to the functional parameters input by the input section and calculates the apparatus cost in the first and second stages.

According to another aspect of the present invention, there is provided a cost information management method that manages cost information relating to production of an apparatus in first and second stages of the production, comprising: an input step that inputs functional parameters for respective circuits constituting the apparatus in the first and second stages and a setting value of apparatus desired cost; and a cost estimation step that calculates the apparatus cost in the first stage based on the main functional parameters input by the input step, compares the calculated value with apparatus desired cost to determine whether to move to the second stage, additionally sets other functional parameters that have not been set in the first stage in the case where it has been determined to move to the second stage so as to calculate the apparatus cost in the second stage, and compares the calculated value with apparatus desired cost.

Further, in the cost information management method according to the present invention, the cost estimation step ends the apparatus development process in the case where the apparatus cost in the second stage is not more than the apparatus desired cost.

Further, the cost information management method according to the present invention comprises an output step that outputs the apparatus cost in the first and second stages calculated by the cost estimation step.

Further, in the cost information management method according to the present invention, a storage section having a cost table in which costs corresponding to the functional parameters set for the respective circuits constituting the apparatus are previously stored are provided, and the cost estimation step refers to the cost table stored in the storage section to obtain the costs of the respective circuits which correspond to the functional parameters input by the input section and calculates the apparatus cost in the first and second stages.

According to still another aspect of the present invention, there is provided a cost information management program allowing a computer to manage cost information relating to production of an apparatus, the program allowing the computer to execute: an input step that inputs functional parameters for respective circuits constituting the apparatus in first and second stages and a setting value of apparatus desired cost; and a cost estimation step that calculates the apparatus cost in the first stage based on the main functional parameters input by the input step, compares the calculated value with apparatus desired cost to determine whether to move to the second stage, additionally sets other parameters that have not been set in the first stage in the case where it has been determined to move to the second stage so as to calculate the apparatus cost in the second stage, and compares the calculated value with apparatus desired cost.

### BRIEF DESCRIPTION OF DRAWINGS

FIG. 1 is a block diagram showing a configuration of a cost information management system according to the present invention;

FIG. 2 is a view for explaining an example of a circuit configuration that constitutes a target apparatus;

FIG. 3 is a view for explaining an example of functional parameters set for circuits constituting the apparatus on a type-by-type basis;

FIG. 4 is a view for explaining the content of a cost table 3A stored in a storage unit 3 of FIG. 1; and

FIG. 5 is a flowchart showing the content of a cost information management program 2A stored in a main memory 2 of FIG. 1 and executed by a central processing unit 1 of FIG. 1.

### BEST MODE FOR CARRYING OUT THE INVENTION

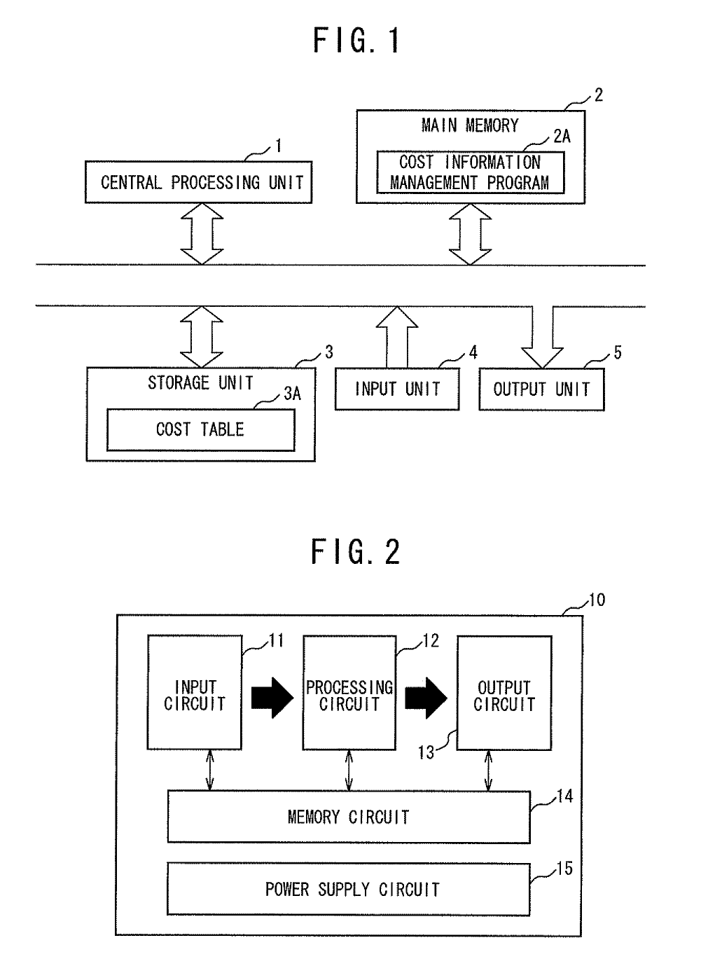

FIG. 1 is a block diagram showing a configuration of a cost information management system according to the present invention.

The cost information management system shown in FIG. 1, which is constituted by a computer that sets functional parameters for respective circuits constituting a target apparatus for cost estimation of the apparatus, includes a central processing unit 1 which serves as a control unit (controller), a main memory 2 which stores a cost information management program 2A for estimating the apparatus cost in a planning stage (corresponding to a first stage of the present invention) and a design stage (corresponding to a second stage of the present invention) based on the functional parameters of the respective circuits constituting the apparatus, a storage unit 3 which stores a cost table 3A previously storing cost data corresponding to the functional parameters of the respective circuits constituting the apparatus, an input unit 4 used for inputting the functional parameters and desired apparatus cost setting values of the respective circuits constituting the apparatus in the respective planning and design stages, and an output unit 5 which outputs the apparatus cost in the respective planning and design stages calculated by the central processing unit 1.

FIG. 2 is a view for explaining an example of a circuit configuration that constitutes the target apparatus.

In general, as shown in FIG. 2, an apparatus 10 includes an input circuit 11, a processing circuit 12, an output circuit 13, a memory circuit 14, and a power supply circuit 15.

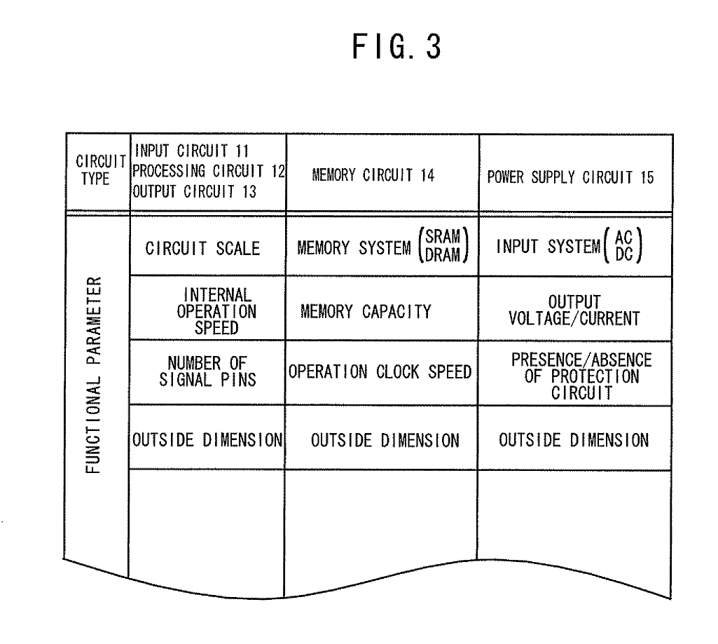

In the present invention, functional parameters are set for the respective circuits constituting such an apparatus on a type-by-type basis, as shown in FIG. 3. That is, functional parameters such as “circuit scale”, “internal operation speed”, “number of signal pins”, and “outside dimension” are set respectively for the input circuit 11, processing circuit 12, and output circuit 13, functional parameters such as “memory system (SRAM, DRAM)”, “memory capacity”, “operation clock speed”, and “outside dimension” are set for the memory circuit 14, and functional parameters such as “input system (AC, DC)”, “output voltage/current”, “presence/absence of protection circuit”, and “outside dimension” are set for the power supply circuit 15.

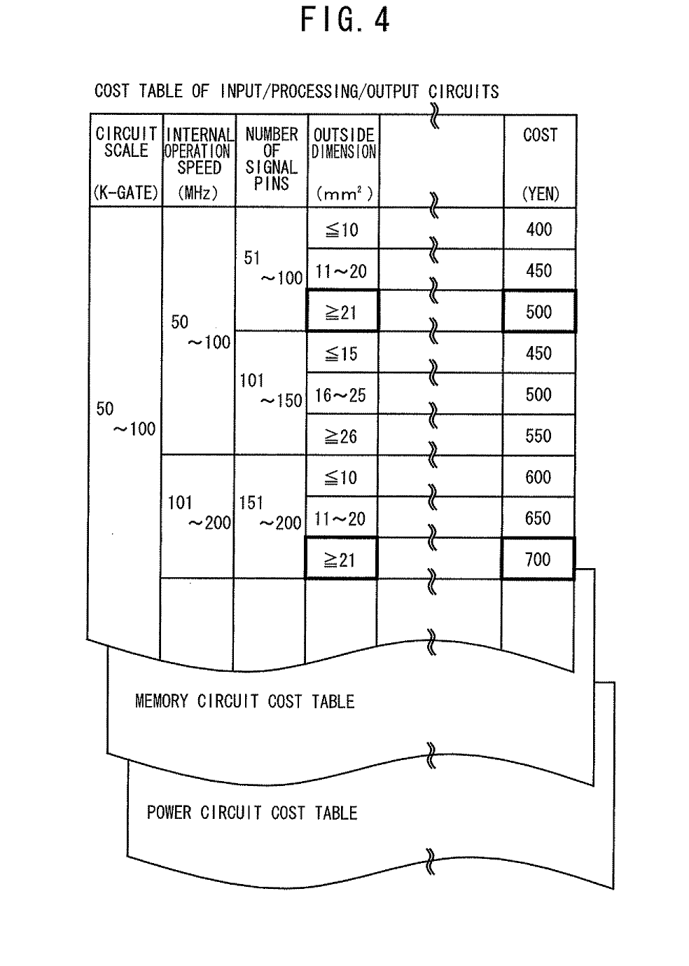

Further, in the present invention, the cost table 3A shown in FIG. 4 is stored in the storage unit 3. The cost table 3A previously stores a correspondence between the functional parameters set for the respective circuits constituting the target apparatus and cost. For example, cost tables each storing data describing costs corresponding to “circuit scale”, “internal operation speed”, “number of signal pins”, “outside dimension” are stored in the input circuit 11, processing circuit 12, and output circuit 13 as the common cost table 13A. The cost tables are set also for the memory circuit 14 and power supply circuit 15.

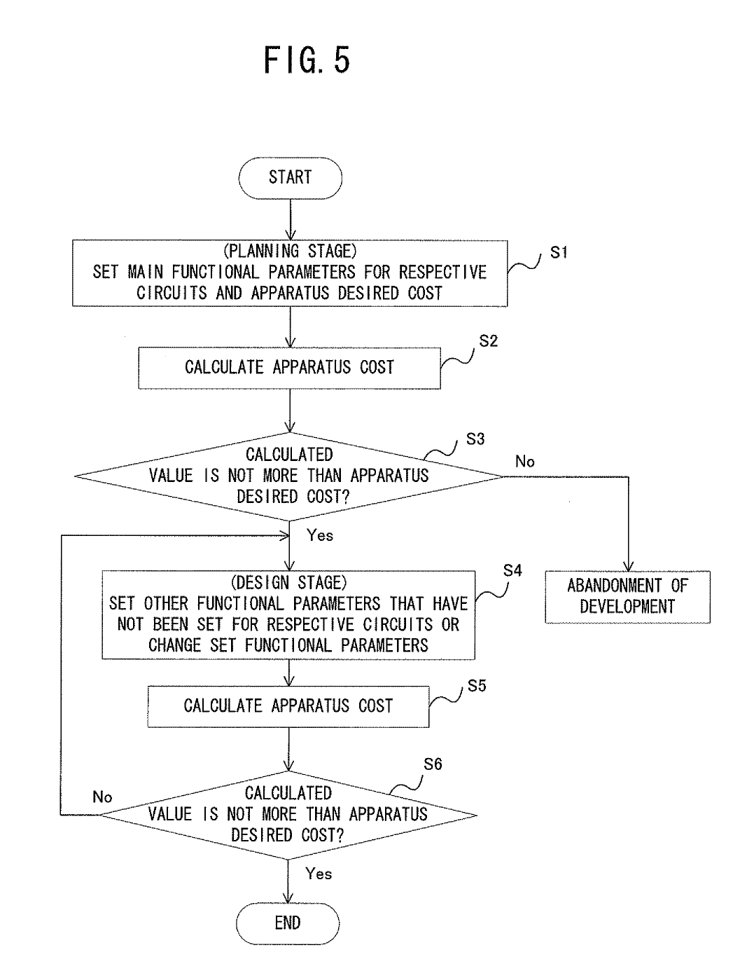

Next, operation of the cost information management system having the above configuration will be described with reference to a flowchart shown in FIG. 5.

FIG. 5 is a flowchart showing the content of a cost information management program 2A stored in the main memory 2 and executed by the central processing unit 1.

First, upon development of an apparatus, main functional parameters for the respective circuits constituting the apparatus and an apparatus desired cost are input through the input unit 4 (step S1) in the apparatus planning stage. For example, circuit scale: 70 k-gate, outside dimension: 22 mm² are input as the functional parameters for input circuit 11, concrete numeric values relating to circuit scale and outside dimension are input as the functional parameters for processing circuit 12 and output circuit 13, concrete numeric values relating to memory scale and outside dimension are input as the functional parameters for the memory circuit 14, and concrete numeric values relating to input system and outside dimension are input as the functional parameters for the power supply circuit 15.

Then, based on the above setting values input as the functional parameters, the central processing unit 1 refers to the cost tables of FIG. 4 to obtain costs corresponding to the functional parameters for the respective circuits and calculates apparatus cost (step S2). For example, as the cost corresponding to the functional parameters (circuit scale: 70 k-gate, outside dimension: 22 mm²) for the input circuit 11, a value range of 500-700 yen encircled by a bold line (FIG. 4) is obtained. In a similar way, costs corresponding to the functional parameters for the processing circuit 12, output circuit 13, memory circuit 14, and power supply circuit 15 are obtained. Then, the total apparatus cost is calculated by summing up the costs for the above respective circuits as follows. The calculated apparatus cost is output as display data by the output unit 5.

Cost of input circuit 11: 500-700 yen

Cost of processing circuit 12: 600-800 yen

Cost of output circuit 13: 600-800 yen

Cost of memory circuit 14: 500-700 yen

Cost of power supply circuit 15: 400-600 yen

Apparatus cost (summation): 2600-3600 yen

Then, the central processing unit 1 determines whether the apparatus cost calculated in the planning stage is not more than the apparatus desired cost or not (step S3). If, e.g., 3000 yen has been set as the apparatus desired cost, development process can be continued since there exists a lower limit of the apparatus cost lower than the apparatus desired cost and is shifted to the design stage. On the other hand, the calculated value of the apparatus cost is larger than the apparatus desired cost value, the development of the apparatus is abandoned.

In the design stage, other functional parameters that have not been set for the respective circuits are set (step S4) and then the apparatus cost is calculated (step S5). The calculated apparatus cost is output as display data by the output unit 5. As a result, variation in the value of the apparatus cost can be reduced to improve the cost accuracy. Then, determination is made based on a comparison between the calculated value of the apparatus cost and apparatus desired cost (step S6). For example, in the input circuit 11, internal operation speed and number of signal pins are additionally set as the functional parameters so as to improve the cost accuracy.

In the case where the value of the apparatus cost calculated as described above is not more than the apparatus desired cost, the apparatus development process is ended. On the other hand, in the case where the value of the apparatus cost calculated as described above is more than the apparatus desired cost, the flow is shifted to step S4 where the functional parameters are changed to thereby execute the subsequent steps S5 and S6.

In the flowchart of FIG. 5, the design stage corresponding to the processing of steps S4 to S6 may be divided into a basic design stage and a detailed design stage to calculate the apparatus cost. In this case, functional parameters of the basic design stage are set in step S4 and, after the determination of step S6 has been completed, the flow returns to step S4 once again where functional parameters of the detailed design stage are set to thereby execute the subsequent steps S5 and S6 once again.

Although the cost table 3A shown in FIG. 4 is stored in the storage unit 3 and this cost table is used to calculate the cost by the central processing unit 1 in the present invention, the following expression can be used to calculate the cost without a use of the cost table 3A.
Cost of input circuit 11=circuit scale×k1+internal operation speed×k2+number of signal pins×k3+outside dimension×k4(k1 to k4: standard unit price)

The cost calculation using the above expression can be applied to the cost calculations for the processing circuit 12, output circuit 13, memory circuit 14 and power supply circuit 15.

Further, the cost information management system can be embodied in the same way as the cost information management method and cost information management program. That is, it is only necessary to follow the respective processing steps and program of the flowchart of FIG. 5.

In this case, by storing a program allowing a computer to execute the respective steps shown in FIG. 5 in a computer-readable storage medium, it is possible to allow the computer to execute the cost information management method.

The computer-readable medium mentioned here includes: a portable storage medium such as a CD-ROM, a flexible disk, a DVD disk, a magneto-optical disk, or an IC card; a database that holds computer program; another computer and database thereof; and a transmission medium on a network line.

As described above, according to the above embodiment, cost of a target apparatus in the planning stage is calculated based on the functional parameters set for the respective circuits constituting the apparatus in the planning stage, the calculated value and apparatus desired cost are compared to each other to thereby determine whether it is possible to move to the design stage, and the apparatus cost in the design stage is calculated after the determination. Thus, it is possible to perform cost estimation with a high level of accuracy without relying on a specialist skill as well as to cover the entire design process of the apparatus from the design upstream stage (development and planning stage) to design down stream stage (detailed design stage), enabling profit and loss to be grasped at the start time of the development project. Although the first and second stages are set respectively as the planning stage and design stage in the present invention, they may arbitrarily be defined.

### INDUSTRIAL APPLICABILITY

According to the present invention, cost of a target apparatus in a first stage (e.g., planning stage) is calculated based on the functional parameters set for the respective circuits constituting the apparatus in the first stage, the calculated value and apparatus desired cost are compared to each other to thereby determine whether it is possible to move to a second stage (e.g., design stage), and the apparatus cost in the second stage is calculated after the determination. Thus, it is possible to perform cost estimation with a high level of accuracy without relying on a specialist skill as well as to cover the entire design process of the apparatus from upstream of the first stage (development and planning stage) to down stream of the second stage (detailed design stage), enabling profit and loss to be grasped at the start time of the development project.

1. A cost information management system that manages cost information relating to production of an apparatus in first and second stages of the production, comprising:
an input section that inputs functional parameters for respective circuits constituting the apparatus in the first and second stages and a setting value of apparatus desired cost; and
a controller that calculates the apparatus cost in the first stage based on the main functional parameters input by the input section, compares the calculated value with apparatus desired cost to determine whether to move to the second stage, additionally sets other functional parameters that have not been set in the first stage in the case where it has been determined to move to the second stage so as to calculate the apparatus cost in the second stage, and compares the calculated value with apparatus desired cost.

2. The cost information management system according to claim 1, wherein
the controller ends the apparatus development process in the case where the apparatus cost in the second stage is not more than the apparatus desired cost.

3. The cost information management system according to claim 1, further comprising an output section that outputs the apparatus cost in the first and second stages calculated by the controller.

4. The cost information management system according to any of claim 1, further comprising a storage section having a cost table in which costs corresponding to the functional parameters set for the respective circuits constituting the apparatus are previously stored, and
the controller refers to the cost table stored in the storage section to obtain the costs of the respective circuits which correspond to the functional parameters input by the input section and calculates the apparatus cost in the first and second stages.

5. A cost information management method that manages cost information relating to production of an apparatus in first and second stages of the production, comprising:
an input step that inputs functional parameters for respective circuits constituting the apparatus in the first and second stages and a setting value of apparatus desired cost; and
a cost estimation step that calculates the apparatus cost in the first stage based on the main functional parameters input by the input step, compares the calculated value with apparatus desired cost to determine whether to move to the second stage, additionally sets other parameters that have not been set in the first stage in the case where it has been determined to move to the second stage so as to calculate the apparatus cost in the second stage, and compares the calculated value with apparatus desired cost.

6. The cost information management method according to claim 5, wherein
the cost estimation step ends the apparatus development process in the case where the apparatus cost in the second stage is not more than the apparatus desired cost.

7. The cost information management method according to claim 5, further comprising an output step that outputs the apparatus cost in the first and second stages calculated by the cost estimation step.

8. The cost information management method according to any of claim 5, wherein
a storage section having a cost table in which costs corresponding to the functional parameters set for the respective circuits constituting the apparatus are previously stored are provided, and
the cost estimation step refers to the cost table stored in the storage section to obtain the costs of the respective circuits which correspond to the functional parameters input by the input section and calculates the apparatus cost in the first and second stages.

9. A cost information management program allowing a computer to manage cost information relating to production of an apparatus, the program allowing the computer to execute:
an input step that inputs functional parameters for respective circuits constituting the apparatus in first and second stages and a setting value of apparatus desired cost; and
a cost estimation step that calculates the apparatus cost in the first stage based on the main functional parameters input by the input step, compares the calculated value with apparatus desired cost to determine whether to move to the second stage, additionally sets other parameters that have not been set in the first stage in the case where it has been determined to move to the second stage so as to calculate the apparatus cost in the second stage, and compares the calculated value with apparatus desired cost.

10. The cost information management program according to claim 9, wherein
the cost estimation step ends the apparatus development process in the case where the apparatus cost in the second stage is not more than the apparatus desired cost.

11. The cost information management program according to claim 9, further comprising an output step that outputs the apparatus cost in the first and second stages calculated by the cost estimation step.

12. The cost information management program according to any of claim 9, wherein
a storage section having a cost table in which costs corresponding to the functional parameters set for the respective circuits constituting the apparatus are previously stored are provided, and
the cost estimation step refers to the cost table stored in the storage section to obtain the costs of the respective circuits which correspond to the functional parameters input by the input section and calculates the apparatus cost in the first and second stages.
